(19) United States
(12) Patent Application Publication
(10) Pub. No.: US 2016/0344831 A1
(43) Pub. Date: Nov. 24, 2016

(54) PROXY SERVICE FOR CONTENT REQUESTS

(71) Applicant: Google Inc., Mountain View, CA (US)

(72) Inventors: Masha Schneider, Guttenberg, NJ (US); Gang Wang, Frederick, MD (US); James Giles, Yorktown Heights, NY (US)

(21) Appl. No.: 14/718,940

(22) Filed: May 21, 2015

(51) Int. Cl. H04L 29/08

(52) U.S. Cl. CPC H04L 67/2809; H04L 67/10; H04L 67/2838

(57) ABSTRACT

Methods, systems, and apparatus include computer programs encoded on a computer-readable storage medium, including a method for providing content. A proxy server is added in between user devices and a server hosting a web resource. A page request addressed to the resource is received at the proxy server from a user device and forwarded to the server. A page associated with the resource is received from the server and processed by the proxy server. The page is parsed, locating content blocks in the page. Slot information for each content block is extracted. Content requests for each content block are forwarded to third-party content serving systems. Received responses are merged into the page at respective content blocks. Tags are removed from items in the responses. A single tag is included in the processed page. A linking between the removed tags and the single tag is stored. The processed page is provided.

### BACKGROUND

This specification relates to information presentation.

The Internet provides access to a wide variety of resources. For example, video and/or audio files, as well as webpages for particular subjects or particular news articles, are accessible over the Internet. Access to these resources presents opportunities for other content (e.g., advertisements) to be provided with the resources. For example, a webpage can include slots in which content can be presented. These slots can be defined in the webpage or defined for presentation with a webpage, for example, along with search results. Content in these examples can be of various formats, while the devices that consume (e.g., present) the content can be equally varied in terms of their type and capabilities.

Publisher pages can include multiple content slots that are configured for receiving content from third-party sources, e.g., partners of the publisher controlling the publisher page. As an example, when a resource (e.g., publisher page) is to be rendered (e.g., in a browser), for each slot of multiple content slots, an individual request can be sent to a corresponding third-party content serving system to obtain content that is to be merged into the publisher page and provided to the user.

### SUMMARY

In general, one innovative aspect of the subject matter described in this specification can be implemented in methods that include a computer-implemented method for providing content. The method includes adding a proxy server in between user devices and a server that hosts a resource on the web. The method further includes receiving, at the proxy server and from a user device, a page request addressed to the resource. The method further includes forwarding the received request to the server. The method further includes receiving, responsive to the forwarding and from the server, a page associated with the resource. The method further includes processing, by the proxy server, the page. Processing the page includes parsing the received page and locating content blocks in the page. Processing the page further includes extracting slot information for each content block. Processing the page further includes forwarding content requests for each content block to respective third-party content serving systems. Processing the page further includes receiving responses to the content requests and merging the responses into the page at respective content blocks. Processing the page further includes removing tags from one or more items in the responses and including a single tag in the processed page that is associated with the proxy server. Processing the page further includes storing a linking between the removed tags and the single tag associated with the proxy server. The method further includes providing the processed page responsive to the received page request.

These and other implementations can each optionally include one or more of the following features. Adding the proxy server can include assigning the proxy server a domain name service name and associated internet protocol address associated with the resource. The method can further include dropping a cookie associated with the proxy server on the user device responsive to the received page request. The method can further include receiving an indication that the single tag associated with proxy server has fired, identifying the removed tags using the linking, and providing a response to one or more sponsors of the removed tags responsive to the received indication. The tags can be tracking pixels or cookies. The method can further include linking cookies deposited directly by a content sponsor with cookies of the proxy server generated when content of the content sponsor is served in response to forwarded requests, and linking the cookies can include linking a cookie dropped on the user device by a content sponsor with the cookie associated with the proxy server based on the stored linking. The method can further include including, in a cookie dropped by a third-party content provider on the user device, a code that pings the proxy server to identify information associated with the third-party content sponsor known by the proxy server as a result of processing the page. The storing a linking can include storing an association between the proxy server tag and one or more of an identifier associated with content provided for a given response, an impression identifier, a page identifier for the page, a current time of impression or a uniform resource locator for a sponsor of the tag. The received page request can include a cookie associated with the publisher of the resource, the forwarded request can include the cookie associated with the publisher resource, and processing the page can include inserting a cookie matching pixel in the processed page that fires a cookie matching event with a third-party content provider's server associated with a respective response. Providing the processed page can further include initially providing a redirect request to redirect a requesting user device's browser associated with the received page request to a third-party content provider server associated with a respective response so as to enable the third-party content provider to drop a cookie directly on the user device's browser as a first-party cookie, and the method can further include thereafter redirecting the user's browser back to the proxy server to enable processing of the page. The tags can include script to pass request-specific, user-specific or publisher specific parameters to an associated tag sponsor when content associated with a respective response is rendered on a requesting device.

In general, another innovative aspect of the subject matter described in this specification can be implemented in computer program products that include a computer program product tangibly embodied in a computer-readable storage device and comprising instructions. The instructions, when executed by one or more processors, cause the processor to: add a proxy server in between user devices and a server that hosts a resource on the web; receive, at the proxy server and from a user device, a page request addressed to the resource; forward the received request to the server; receive, responsive to the forwarding and from the server, a page associated with the resource; and process, by the proxy server, the page including: parsing the received page and locating content blocks in the page; extracting slot information for each content block; forwarding content requests for each content block to respective third-party content serving systems; receiving responses to the content requests and merging the responses into the page at respective content blocks; removing tags from one or more items in the responses and including a single tag in the processed page that is associated with the proxy server; and storing a linking between the removed tags and the single tag associated with the proxy server; and provide the processed page responsive to the received page request.

These and other implementations can each optionally include one or more of the following features. Adding the proxy server can include assigning the proxy server a domain name service name and associated internet protocol address associated with the resource. The instructions can further include instructions to drop a cookie associated with the proxy server on the user device responsive to the received page request. The instructions can further include instructions to receive an indication that the single tag associated with proxy server has fired, identify the removed tags using the linking, and provide a response to one or more sponsors of the removed tags responsive to the received indication. The tags can be tracking pixels or cookies.

In general, another innovative aspect of the subject matter described in this specification can be implemented in systems, including a system comprising one or more processors and one or more memory elements including instructions. The instructions, when executed, cause the one or more processors to: add a proxy server in between user devices and a server that hosts a resource on the web; receive, at the proxy server and from a user device, a page request addressed to the resource; forward the received request to the server; receive, responsive to the forwarding and from the server, a page associated with the resource; and process, by the proxy server, the page including: parsing the received page and locating content blocks in the page; extracting slot information for each content block; forwarding content requests for each content block to respective third-party content serving systems; receiving responses to the content requests and merging the responses into the page at respective content blocks; removing tags from one or more items in the responses and including a single tag in the processed page that is associated with the proxy server; and storing a linking between the removed tags and the single tag associated with the proxy server; and provide the processed page responsive to the received page request.

These and other implementations can each optionally include one or more of the following features. Adding the proxy server can include assigning the proxy server a domain name service name and associated internet protocol address associated with the resource. The instructions can further include instructions to drop a cookie associated with the proxy server on the user device responsive to the received page request. The instructions can further include instructions to receive an indication that the single tag associated with proxy server has fired, identify the removed tags using the linking, and provide a response to one or more sponsors of the removed tags responsive to the received indication.

Particular implementations may realize none, one or more of the following advantages. A user's mobile web experience can be improved by increasing content rendering speed, reducing bandwidth consumption, and extending battery life on mobile devices. A single trusted party (e.g., embodied in a proxy service) can control and limit third- or fourth-party tracking of a user's online activity, resulting in increased protection of the user's online privacy. The need for ad blockers can be reduced, therefore protecting revenue and business value for legitimate publishers and third-party content providers (e.g., advertisers). Legitimate publishers' revenue sources can be protected, enabling the publishers to continue providing free (e.g., ad-supported) content to Internet users. Compared to a server-side approach, the proxy service solutions proposed can result in reduced integration costs for publishers, third-party content providers, and fourth-party tracking providers. These and other advantages may be realized with minimum or no changes to existing servers of publishers, third-party content providers, and fourth-party tracking providers.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for providing content.

FIG. 2 shows an example system for inserting a proxy server between a client user device that generates page a request for a publisher page and a publisher resource server.

FIG. 3 is a flowchart of an example process for processing content requests using a proxy server.

FIG. 4 is a block diagram of an example computer system that can be used to implement the methods, systems and processes described in this disclosure.

Like reference numbers and designations in the various drawings indicate like elements.

### DETAILED DESCRIPTION

Systems, methods, and computer program products are described for providing content. For example, a proxy server can be added in between user devices and a server that hosts a resource on the web. A page request from a user device can be received at the proxy server, the page request being addressed to the resource. The received page request can be forwarded to the server. In response to the forwarded request, a page associated with the resource can be received from the server. The page can be processed by the proxy server prior to (or in parallel with) delivery to the user device. For example, processing can include parsing the received page and locating content blocks in the page. Slot information for each content block can also be extracted. Using the slot information, content requests for each content block can be forwarded to respective third-party content serving systems. Responses to the content requests can be received, and the responses can be merged into the page at the respective content blocks. Tags (e.g., tracking pixels, cookies or other forms of interaction detection elements) can be removed from one or more items in the responses, and a single tag can be created. In some implementations, for example, a new tag pointing to the proxy server can be merged into the page. In some implementations, in parallel the content requests to respective third-party content serving systems can be issued and the responses can be stored and later returned to the respective third-party content serving systems when the new tag is requested. A linking between the removed tags and the single tag can be stored. The processed page can then be provided responsive to the received page request. In some implementations, the proxy server can fetch the content in parallel with an initial page that is provided.

Use of the proxy server can improve efficiency in handling requests for content. For example, it is common practice that, when an Internet user browses a website, the publisher may have space reserved on its webpages (e.g., slots). To fill the slots, for example, third-party content providers may partner with the publisher to provide third-party content. To facilitate delivery of the third-party content, for example, the publisher may embed a tag (e.g., in a scripting language) in each slot. When a webpage is rendered within the Internet user's browser, for example, the tags can be used to send requests to third-party content providers' servers to retrieve content customized for the Internet user, page or both. This approach is commonly known as client-side ads for online advertising.

In addition, either the publisher (e.g., first-party) or third-party content providers may embed tags (e.g., tracking pixels) or other scripts in content returned to a user's browser. Once rendered, the tags can report back to various servers to allow those servers to track a user's interaction, browsing history or other conduct. The embedded tags can have multiple drawbacks. For example, the tags can slow down content rendering by the browser, which can be detrimental to the user's experience. Further, the use of tags can result in the generation and processing of multiple requests over the Internet, e.g., consuming precious bandwidth and battery life for a mobile device, which can degrade a mobile user's experience. Finally, the use of tags can allow multiple parties on the Internet to track the user online, which can pose a threat to the user's online privacy. The use of a proxy server, for example, can eliminate or mitigate these problems.

Some implementations can use a proxy server, for example, within a hybrid between client-side ads (e.g., the current industry practice) and server-side ads. These and other implementations may require minimal changes to servers of publishers.

For situations in which the systems discussed here collect and/or use personal information about users, the users may be provided with an opportunity to enable/disable or control programs or features that may collect and/or use personal information (e.g., information about a user's social network, social actions or activities, a user's preferences or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

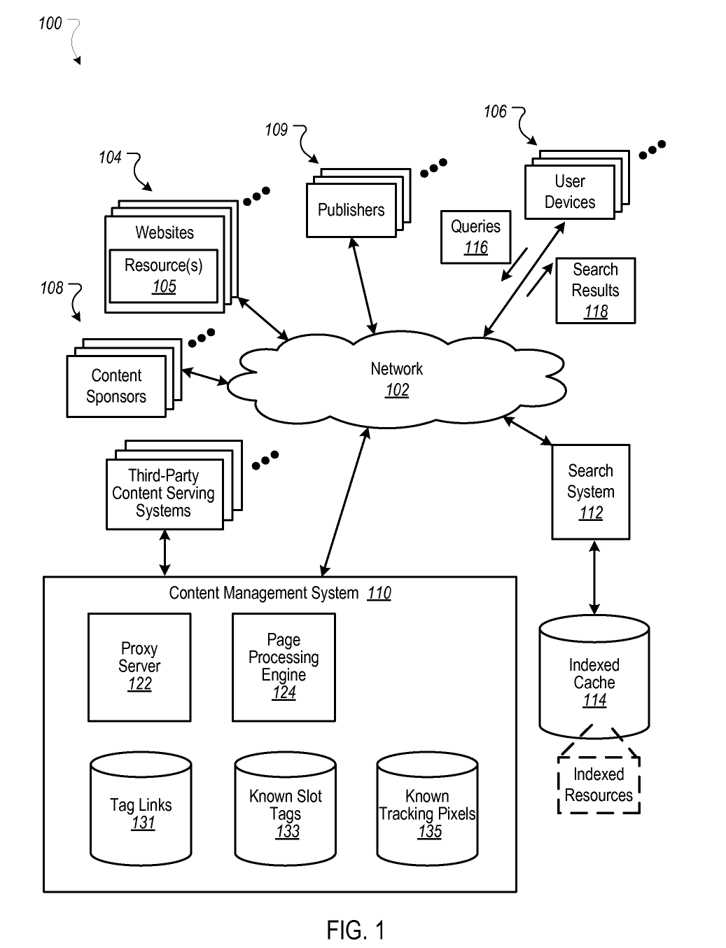

FIG. 1 is a block diagram of an example environment 100 for providing content. The example environment 100 includes a content management system 110 for selecting and providing content in response to requests for content. The example environment 100 includes a network 102, such as a local area network (LAN), a wide area network (WAN), the Internet, or a combination thereof. The network 102 connects websites 104 (e.g., addressable resources), user devices 106, content sponsors 108 (e.g., advertisers), publishers 109, and the content management system 110. Plural third-party content serving systems 111 can provide third-party content, such as to fill slots on resources 105. The example environment 100 may include many thousands of websites 104, user devices 106, content sponsors 108, publishers 109, and third-party content serving systems 111.

The environment 100 can include plural data stores, which can be stored locally by the content management system 110, stored somewhere else and accessible using the network 102, generated as needed from various data sources, or some combination of these. Further, some data stores described herein may include identifiers that can be used to match or access corresponding data records or other information that are stored elsewhere, e.g. locally and/or remotely.

A data store of tag links 131, for example, can include linking information that links tags (e.g., cookies, tracking pixels, or other tags). For example, the data store of tag links 131 can link a tag created by the proxy server 122 and associated with a resource to plural tags associated with third-party content providers for content slots on the resource.

A data store of known slot tags 133, for example, can include information associated with patterns of supported slot tags, including information that can be used to pattern-match tags in the content blocks in order to extract parameters from slot definitions. The information can also include information that specifies how to invoke a particular third-party content provider with the extracted parameters to retrieve third-party content, how to merge the retrieved third-party content into the corresponding slot within the publisher's original content, and/or how to match the publisher's browser cookie to the third-party content provider's browser cookie.

A data store of known tracking pixels 135, for example, can include information used to identify patterns of known/supported tracking pixels. The information can include, for example, information specifying how to pattern-match those tracking pixels to extract parameters from those tracking pixels (including destination URLs), how to match the publisher's browser cookie with the destination servers' browser cookies, and/or how to invoke the destination servers to report permissible events.

The content management system 110 can include plural engines, some or all of which may be combined or separate, and may be co-located or distributed (e.g., connected over the network 102). The proxy server 122, for example, can be added in between user devices 106 and servers that host resources on the web. For example, the proxy server 122 can receive a page request from the user device 106 and forward the request to a server associated with the resource. In response to the forwarded request, a page associated with the resource (and) can be received from the server. The page can be processed by a page processing engine 124 before being provided to the user device 106.

A page processing engine 124, for example, can parse the received page, locate content blocks in the page, and extract slot information for each content block. Using the slot information, the page processing engine 124 can forward content requests for each content block to respective third-party content serving systems 111. When the responses to the content requests are received, the page processing engine 124 can merge the responses into the page at the respective content blocks. The page processing engine 124 can replace tags from one or more items in the responses and include/embed a single tag associated with the proxy server 122 into the page. A linking between the removed tags and the single tag associated with the proxy server 122 can be stored, e.g., in the data store of tag links 131.

A website 104 includes one or more resources 105 associated with a domain name and hosted by one or more servers. An example website is a collection of webpages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images, video and sounds, that may include embedded information (such as meta-information hyperlinks) and/or embedded instructions (such as JavaScript™ scripts).

A user device 106 is an electronic device that is under control of a user and is capable of requesting and receiving resources over the network 102. Example user devices 106 include personal computers (PCs), televisions with one or more processors embedded therein or coupled thereto, set-top boxes, gaming consoles, mobile communication devices (e.g., smartphones), tablet computers and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or webpage, in which content can be presented. These specified portions of the resource or user display are referred to as slots (e.g., ad slots).

To facilitate searching of these resources, the environment 100 can include a search system 112 that identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 can, for example, access the indexed cache 114 to identify resources that are relevant to the search query 116. The search system 112 identifies the resources in the form of search results 118 and returns the search results 118 to the user devices 106 in search results pages. A search result 118 can be data generated by the search system 112 that identifies a resource that is provided in response to a particular search query, and includes a link to the resource. Search results pages can also include one or more slots in which other content items (e.g., advertisements) can be presented.

When a resource 105, search results 118 and/or other content (e.g., a video) are requested by a user device 106, the content management system 110 receives a request for content. The request for content can include characteristics of the slots that are defined for the requested resource or search results page, and can be provided to the content management system 110.

For example, a reference (e.g., URL) to the resource for which the slot is defined, a size of the slot, and/or media types that are available for presentation in the slot can be provided to the content management system 110 in association with a given request. Similarly, keywords associated with a requested resource (“resource keywords”) or a search query 116 for which search results are requested can also be provided to the content management system 110 to facilitate identification of content that is relevant to the resource or search query 116.

Based at least in part on data included in the request, the content management system 110 can select content that is eligible to be provided in response to the request (“eligible content items”). For example, eligible content items can include eligible ads having characteristics matching the characteristics of ad slots and that are identified as relevant to specified resource keywords or search queries 116. In addition, when no search is performed or no keywords are available (e.g., because the user is not browsing a webpage), other information, such as information obtained from one or more snapshots, can be used to respond to the received request. In some implementations, the selection of the eligible content items can further depend on user signals, such as demographic signals, behavioral signals or other signals derived from a user profile.

The content management system 110 can select from the eligible content items that are to be provided for presentation in slots of a resource or search results page based at least in part on results of an auction (or by some other selection process). For example, for the eligible content items, the content management system 110 can receive offers from content sponsors 108 and allocate the slots, based at least in part on the received offers (e.g., based on the highest bidders at the conclusion of the auction or based on other criteria, such as those related to satisfying open reservations and a value of learning). The offers represent the amounts that the content sponsors are willing to pay for presentation of (or selection of or other interaction with) their content with a resource or search results page. For example, an offer can specify an amount that a content sponsor is willing to pay for each 1000 impressions (i.e., presentations) of the content item, referred to as a CPM bid. Alternatively, the offer can specify an amount that the content sponsor is willing to pay (e.g., a cost per engagement) for a selection (i.e., a click-through) of the content item or a conversion following selection of the content item. For example, the selected content item can be determined based on the offers alone, or based on the offers of each content sponsor being multiplied by one or more factors, such as quality scores derived from content performance, landing page scores, a value of learning, and/or other factors.

A conversion can be said to occur when a user performs a particular transaction or action related to a content item provided with a resource or search results page. What constitutes a conversion may vary from case-to-case and can be determined in a variety of ways. For example, a conversion may occur when a user clicks on a content item (e.g., an ad), is referred to a webpage, and consummates a purchase there before leaving that webpage. A conversion can also be defined by a content provider to be any measurable or observable user action, such as downloading a white paper, navigating to at least a given depth of a website, viewing at least a certain number of webpages, spending at least a predetermined amount of time on a web site or webpage, registering on a website, experiencing media, or performing a social action regarding a content item (e.g., an ad), such as endorsing, republishing or sharing the content item. Other actions that constitute a conversion can also be used.

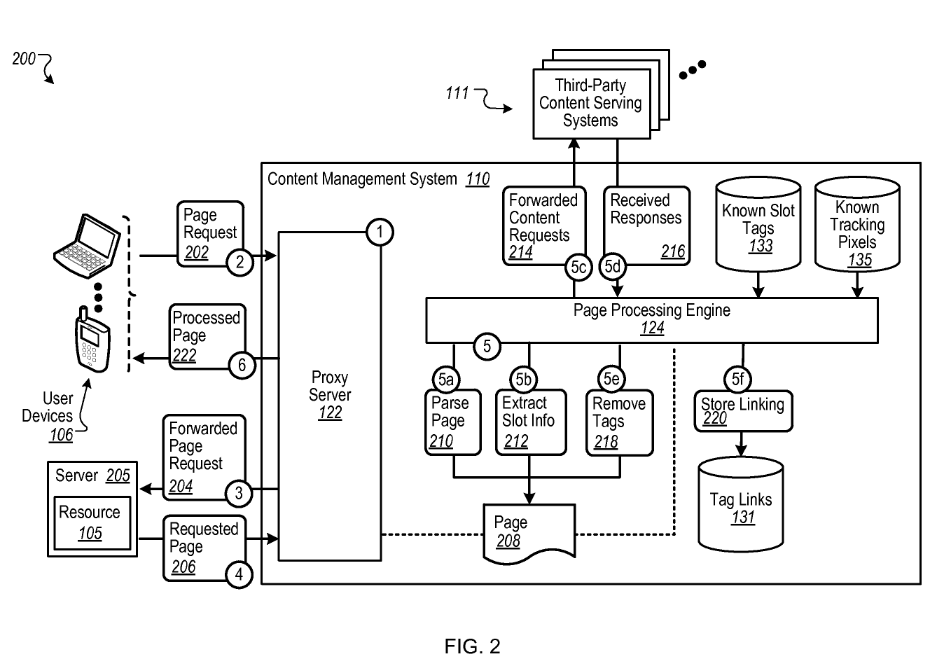

FIG. 2 shows an example system 200 for inserting a proxy server between a client user device that generates page a request for a publisher page and a publisher resource server. For example, the proxy server 122 can receive a page request 202 for a resource 105 and forward the request to a server 205 associated with the resource 105. The proxy server 122 can process the received page, including requesting third-party content (e.g., from third-party content serving systems 111) for slots in the page, and provide the processed page in response to the original request. In some implementations, the following example stages can be used for receiving and responding to received requests for content.

At stage 1, for example, the proxy server 122 is added in between user devices and a server that hosts a resource on the web. For example, the proxy server 122 can be added in front of a publisher's existing server. As such, the proxy server 122 assumes the publisher's existing server's domain name system (DNS) name (e.g., www.publisherXdomain.com) and internet protocol (IP) address. The publisher's existing server can be assigned and receive a new IP address accessible by the proxy server 122.

In some implementations, the content management system 110 can invoke the proxy server 122 in certain instances, such as dependent on types of requests received from one or more of the user devices 106. Whether or not to use the proxy server 122 can depend, for example, on various conditions, such as including a device type (e.g., mobile, non-mobile) associated with a given request. As such, the content management system 110 can provide or use an instance of the proxy server 122 as needed on a per-publisher basis or based on other conditions.

At stage 2, for example, the proxy server 122 can receive, from a user device 106, a page request 202 addressed to the resource 105. For example, when a user's browser sends an HTTP/HTTPS request to the DNS name or IP address associated with the publisher e.g., to retrieve a webpage, the request can be directed to (or intercepted by) the proxy server 122 for processing. In some implementations, along with the request, the client device browser that generated the request can automatically include the publisher's browser cookie with a given request, e.g., by attaching the publisher's browser cookie to the request.

At stage 3, for example, the proxy server 122 can forward (e.g., using a forwarded page request 204) the received page request 202 to the server 205 (e.g., the publisher's server). As an example, the proxy server 122 can forward the request to the publisher's own server, such as the server 205, along with the publisher's own browser cookie. The proxy server 122 can attach the user device's IP address in the HTTP header's original IP address field, for example. While reference is made to the proxy server intercepting the request, in some implementations, the server 205 can receive the request and can pass the page to the proxy server 122 with a redirect back to the user device 106. For example, replaced embedded tags can be forwarded, or the tags can point directly to the proxy server 122.

At stage 4, for example, the proxy server 122 can receive, from the server 205, a requested page 206 associated with the resource 105. For example, the server 205, can serve the publisher's content as if there were no proxy standing in between the publisher's server and the user's browser. The requested page 206 that is received is responsive to the forwarded page request 202. A page 208, for example, represents the received page, initially including the content of the requested page 206 and further processed by the page processing engine 124, including updating the page 208 as a result of the processing.

At stage 5, for example, by the page processing engine 124 can process the page 208. In some implementations, processing the page 208 can include the following sub-stages.

At stage 5a, for example, the page processing engine 124 can parse (210) the page 208 to locate content blocks in the page 208. For example, the publisher's content received by the proxy server 122 can include slots for which requests can be made for third-party content (e.g., from partners of the publisher). The page processing engine 124 can identify the slots, for example.

At stage 5b, for example, the page processing engine 124 can extract (212) slot information for each content block in the page 208. For example, the page processing engine 124 can determine characteristics of various slots identified in stage 5a. The characteristics can include, for example, addresses for the third-party content providers' servers.

In some implementations, the page processing engine 124 can use a data store of known slot tags 133 to identify and determine the slot information. For example, using slot information located in the resource 105, the page processing engine 124 can determine (e.g., using a look-up) if matching/relevant information exists in the data store of known slot tags 133. If information exists in the data store for a particular slot, the page processing engine 124 can use the information to determine how to invoke a particular third-party content provider with the extracted parameters to retrieve the required third-party content. In some implementations, the information can also specify how to merge the retrieved third-party content into the corresponding slot within the publisher's original content, and how to match the publisher's browser cookie to the third-party content provider's browser cookie.

At stage 5c, for example, the page processing engine 124 can forward (214) content requests for each content block to respective third-party content serving systems 111. For example, for each tag that was successfully extracted based on the database content, the proxy server 122 can invoke the corresponding third-party content serving system 111 to retrieve the third-party content. In some implementations, any tags that are unrecognizable can be ignored by the proxy server 122, e.g., as would be done in situations not using a proxy server.

At stage 5d, for example, the page processing engine 124 can receive responses 216 responsive to the content requests and merge the responses 216 into the page 208 at respective content blocks. For example, the page processing engine 124 can merge the third-party content into the slot defined in the publisher's original content. In some implementations, a new tag can be included in the page 208 that points to an image returned to the proxy server 122. The new tag can be inserted, for example, before content requests are forwarded (214), and a version of the page 208 can be returned to the user device 106 in parallel.

At stage 5e, for example, the page processing engine 124 can remove (218) tags from one or more items in the responses and include a single tag in the page 208 that is associated with the proxy server 122. Tags can include, for example, tracking pixels, cookies, or other types of information retrieval instruments. For example, tracking pixels can be used for tracking which pages the user is visiting, or for tracking whether a conversion has occurred. The page processing engine 124, for example, can recognize and locate each tracking pixel in the publisher's content merged with third-party content providers' content. The tracking pixels can be identified, for example, as tracking pixels T₁, T₂, . . . Tₙ. The page processing engine 124 can remove each of tracking pixels T₁, T₂, . . . Tₙ and replace them with a single tracking pixel, e.g., T₀. In addition, the page processing engine 124 can insert the single tracking pixel T₀ into the merged content that points back to the proxy server 122.

In some implementations, the page processing engine 124 can use the data store of known tracking pixels 135 to generate the single tag. For example, using a tracking pixel located in or associated with the resource 105, the page processing engine 124 can determine (e.g., using a data store look-up) if associated information exists in the data store of known tracking pixels 135. If information exists, the page processing engine 124 can access information for identifying patterns of known/supported tracking pixels. The information can include, for example, information for pattern-matching particular tracking pixel tags to extract parameters from those tracking pixels (including destination URLs), information for matching the publisher's browser cookie with the destination servers' browser cookies, and information for invoking the destination servers to report permissible events.

At stage 5f, for example, the page processing engine 124 can store (220) a linking between the removed tags and the single tag associated with the proxy server 122. As an example, the page processing engine 124 can record at least the extracted tracking information (e.g., destination URL, additional parameters) in the data store of tag links 131. The information stored, for example, can associate tracking pixel T₀ with tracking pixels T₁, T₂, . . . Tₙ. In some implementations, the page processing engine 124 can store other types of content in addition to information linking tags.

At stage 6, for example, the content management system 110 can provide a processed page 222 responsive to the received page request 202. For example, the processed page 222 can be the final version of the page 208 after being processed by the page processing engine 124. The processed page 222 can include, for example, the publisher's content modified by merging third-party content and replacement of plural third-party tracking pixels with the proxy server's own tracking pixel (and/or content links replaced by content links pointing to the proxy server 122).

At the user device 106, when the publisher's content is rendered in the user's browser, the proxy server's tracking pixel fires a request to the proxy server 122. When the content management system 110 receives information associated with the fired tracking pixel (e.g., tracking pixel T₀), the proxy server 122 can use tracking pixel T₀ to retrieve relevant information for tracking pixels T₁, T₂, . . . Tₙ from the data store of tag links 131, and the proxy server 122 can send tracking requests associated with tracking pixels T₁, T₂, . . . Tₙ to the corresponding destination servers (e.g., third-party content serving systems 111) accordingly.

In some implementations, cookie matching can be established between a publisher's browser cookie and a third-party content providers' cookie and/or a fourth-party trackers' cookie. For example, this can be done by adapting one of various industry common practices as follows. In some implementations that use a push approach, for example, the proxy server 122 can insert a cookie matching pixel in the modified content before the processed page 222 is provided to the user device 106. The cookie matching pixel, once rendered in the user's browser, can fire up a cookie matching event with the third-party content provider's server, which can optionally redirect back to the proxy server 122. In some implementations, a push approach can be used, for example in situations in which the user's browser blocks third-party cookies. For example, when the proxy server 122 receives a request from the browser, the proxy server 122 can reply with a redirect request to redirect the user's browser to the third-party content provider's server, which can drop its own cookie to the user's browser as a first-party cookie. Then the user's browser can be redirected back to the proxy server, which can serve the content as described above. In some implementations, cookie-matching can be initiated by a third-party content provider. For example, when the third-party content provider drops a cookie matching pixel to the user's browser, the cookie matching pixel can send a request to the proxy server. In this example, there can optionally be a redirect back to the third-party content provider's server.

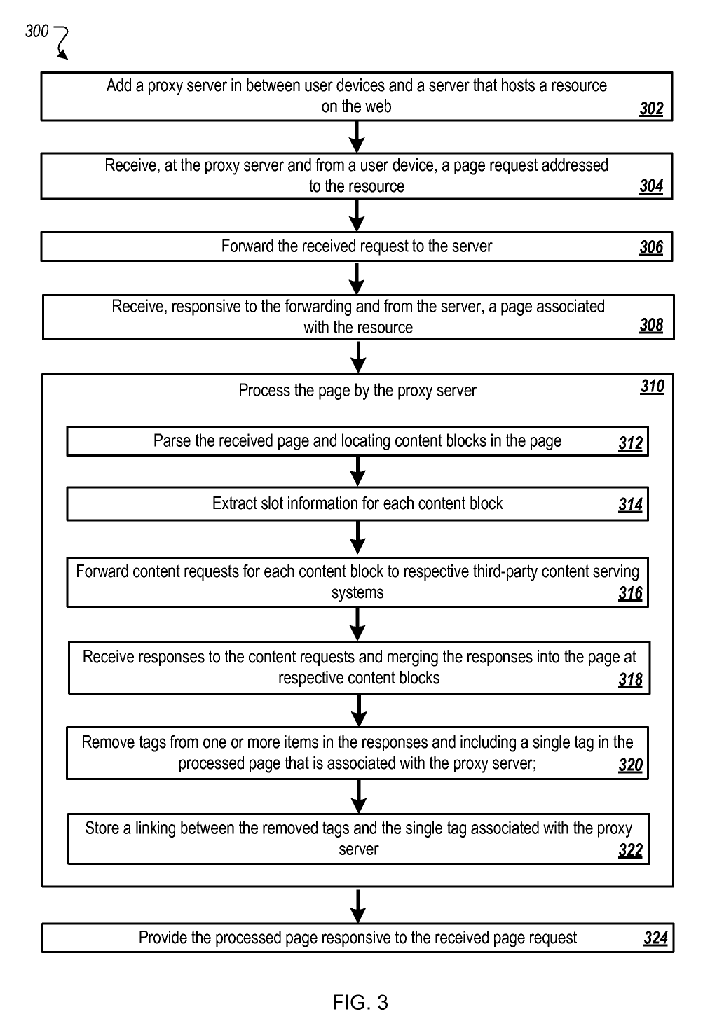

FIG. 3 is a flowchart of an example process 300 for processing content requests using a proxy server. In some implementations, the content management system 110 can perform steps of the process 300 using instructions that are executed by one or more processors. FIGS. 1-2 are used to provide example structures for performing the steps of the process 300.

A proxy server is added in between user devices and a server that hosts a resource on the web (302). For example, the content management system 110 can include the proxy server 122 for serving as a proxy between requesting sources (e.g., user devices 106) and third-party content serving systems 111.

In some implementations, adding the proxy server includes assigning the proxy server a domain name service name and associated internet protocol address associated with the resource. For example, the proxy server 122 can assume the URL or IP address of a corresponding resource 105.

A page request addressed to the resource is received at the proxy server and from a user device (304). As an example, the content management system 110 can receive the page request 202 from the user device 106, the page request being for a particular resource 105.

In some implementations, the process further includes dropping a cookie associated with the proxy server on the user device responsive to the received page request. For example, in response to the page request 202, the proxy server 122 can provide a cookie to the user device 106 that initiated the page request 202. A publisher's existing web server may have already dropped cookies into a user's browsers, e.g., before use of the proxy server 122. In some implementations, because the proxy server 122 takes over the publisher's domain, the proxy server 122 can re-use existing cookies dropped by the publisher's web server prior to installing the proxy. As a result, the proxy server 122 may only drop a cookie if the publisher's web server has not already done so.

The received request is forwarded to the server (306). For example, the proxy server 122 can provide the forwarded page request 204 to the server 205. In some implementations, the server 205, in this case, does not know the source of the page request, e.g., that the page request is from a proxy server.

A page associated with the resource is received responsive to the forwarding and from the server (308). As an example, the server 205 can provide, to the proxy server 122, the requested page 206 that is identified by the request.

The page is processed by the proxy server (310). For example, the page processing engine 124 can process the requested page 206, as described above. During the processing, the page 208, for example, can serve as a working copy of the received requested page 206, updated by one or more of the following steps.

The received page is parsed and content blocks in the page are located (312). As an example, the page processing engine 124 can identify, within the page 208, one or more content blocks for incorporating third-party content, as described above.

Slot information for each content block is extracted (314). For example, for each identified content block, the page processing engine 124 can extract the slot information, such as including the information to request third-party content from specific third-party content serving systems 111.

Content requests for each content block are forwarded to respective third-party content serving systems (316). As an example, the page processing engine 124 can forward (214) content requests to respective ones of the third-party content serving systems 111. In some implementations, forwarded requests can occur in parallel to providing the page, e.g., replacing links in the content blocks with pointers to the proxy server and the returning the page to the client device 106 while the content requests are forwarded.

Responses to the content requests are received, and the responses are merged into the page at respective content blocks (318). For example, using the content in the received responses 216, the page processing engine 124 can update the page 208.

Tags are removed from one or more items in the responses and a single tag is included in the processed page that is associated with the proxy server (320). As an example, the page processing engine 124 can update the page 208 by removing each of tracking pixels T₁, T₂, . . . Tₙ and replacing them with the single tracking pixel, e.g., tracking pixel T₀ in the page 208. Tags can include, for example, tracking pixels, cookies, or other types of information reporting elements.

In some implementations, the tags include a script to pass request-specific, user-specific or publisher specific parameters to an associated tag sponsor when content associated with a respective response is rendered on a requesting device. For example, the tracking pixels T₁, T₂, . . . Tₙ replaced by the page processing engine 124 can include information associated with one or more of a particular user of the user device 106, the specific page request 202, and/or the resource 105 associated with the page request 202.

A linking between the removed tags and the single tag associated with the proxy server is stored (322). For example, the page processing engine 124 can replace the tracking pixels T₁, T₂, . . . Tₙ with the single tracking pixel T₀, as described above, and store a linking in the data store of tag links 131.

In some implementations, storing the linking includes storing an association between the proxy server tag, third-party content, and one or more of an identifier associated with content provided for a given response, an impression identifier, a page identifier for the page, and/or a current time of impression or a uniform resource locator for a sponsor of the tag. For example, the information stored in the data store of tag links 131 associating the tracking pixels T₁, T₂, . . . Tₙ with the single tracking pixel T₀ can include information associated with serving the requested page 206. The information can identify, for example, the specific content item provided, the specific impression, a date/timestamp of the impression, and/or the URL associated with the sponsor.

The processed page is provided responsive to the received page request (324). As an example, the proxy server 122 can provide the processed page 222 (e.g., the final state of the page 208) to the user device 106 in response to the page request 202.

In some implementations, providing the processed page further includes initially providing a redirect request to redirect a requesting user device's browser associated with the received page request to a third-party content provider server associated with a respective response. The redirect request, for example, can enable the third-party content provider to drop a cookie directly on the user device's browser as a first-party cookie. The method can further include thereafter redirecting the user's browser back to the proxy server to enable processing of the page. For example, the processed page 222 can include a redirect URL that, when processed by the browser at the user device 106, causes a redirection to a server of the third-party content serving system 111, the re-direction including use of a cookie dropped on the user device 106.

In some implementations, the process 300 further includes receiving an indication that the single tag associated with proxy server has fired, identifying the removed tags using the linking, and providing a response to one or more sponsors of the removed tags responsive to the received indication. For example, the proxy server 122 can receive a notification that the single tracking pixel T₀ has fired. The proxy server 122 can use the single tracking pixel T₀ to look up the associated tracking pixels T₁, T₂, . . . Tₙ in the data store of tag links 131. The proxy server 122 can notify sponsors associated with the tracking pixels T₁, T₂, . . . Tₙ that the tracking pixels have fired. In some implementations, the proxy server 122 can also parse the HTML snippets returned by a respective content provider, and can either remove tags or can call respective content providers based on the recognized tags. This process can be recursive using, for example, third-party ad servers. For example, rather than serve an ad directly to the user's browser, the publisher can deliver an ad tag which can redirect the browser to an ad server where the ad is stored.

In some implementations, the process 300 further includes linking cookies deposited directly by a content sponsor with cookies of the proxy server generated when content of the content sponsor is served in response to forwarded requests, wherein linking the cookies includes linking a cookie dropped on the user device by a content sponsor with the cookie associated with the proxy server based on the stored linking. For example, the page processing engine 124, when storing (220) a linking in the data store of tag links 131, can link cookies provided by the proxy server 122 and the third-party content serving systems.

In some implementations, the process 300 further includes including, in a cookie dropped by a third-party content provider on the user device, a code that pings the proxy server to identify information associated with the third-party content sponsor known by the proxy server as a result of processing the page. For example, the processed page 222 can include a code snippet for requesting, from the proxy server 122, information associated with the third-party content serving systems 111 (corresponding to third-party content merged into the processed page 222).

In some implementations, the received page request includes a cookie associated with the publisher of the resource, the forwarded request includes the cookie associated with the publisher resource, and processing the page includes inserting a cookie matching pixel in the processed page that fires a cookie matching event with a third-party content provider's server associated with a respective response. As an example, the processed page 222 provided to the user device 106 can include a cookie associated with the publisher of the resource 105, the cookie inserted by the page processing engine 124 for matching cookies upon pixel firing at the user device 106. In some implementations, inserting a cookie matching pixel can be done on an as-needed basis, e.g., if the inserting has not been done before. In some implementations, these content providers can be selected, e.g., to maximize potential ads revenue based on their past ads-buying history or spending potential.

In some implementations, the proxy server 122 can perform actions in a different sequence from that identified by the process 300, e.g., including sending content requests to content providers only after receiving a page from the publisher. For example, to minimize latency, the proxy server 122 can perform the following steps. The page content can be cached, e.g., caching occurring only for information related to how many slots are on the page, size of those slots, tags of the slots, etc. Based on the cached slot information, the proxy server 122 can send requests to the publisher and to content providers at the same time (e.g., pre-fetching). After receiving the publisher's page, the proxy server 122 can parse the page to extract slot information, then send additional requests to content providers for those slots that the proxy server has not yet pre-fetched. The proxy server can also update the cached ad slot information. In some implementations, the proxy server may not send some of the pre-fetched content to the user's browser, e.g., when the cached slot information does not match the publisher's page just retrieved. In this case, the pre-fetched content can be discarded if the content provider relies on a delayed impression pixel to track whether the content is actually displayed in user's browsers. In some implementations, the publisher′ web server can indicate to the proxy server 122 that the page is static, using standard HTML protocol. Therefore, the proxy server 122 can cache the page content and omit the call to the publisher's web server in some scenarios, e.g., to reduce the load to the publisher's server and perhaps further reduce latency.

In some implementations, the proxy server 122 can rewrite the page content in many ways, e.g., to speed up paging rendering, to improve user experience, or to provide additional benefits to publishers. For example, the proxy server 122 can rewrite/compress the Javascript embedded in the page to reduce the size. If user's browser does not support some content (either a publisher's content or a third-party provider's content), the proxy server 122 can convert the content to a format supported by the user's browser and return the converted content to the user's browser. The publisher's web server need only to receive requests from the proxy server 122. If the proxy server 122 is protected by a firewall, for example, the firewall can indirectly protect the publisher's web server as well without requiring the publisher to deal with an attack.

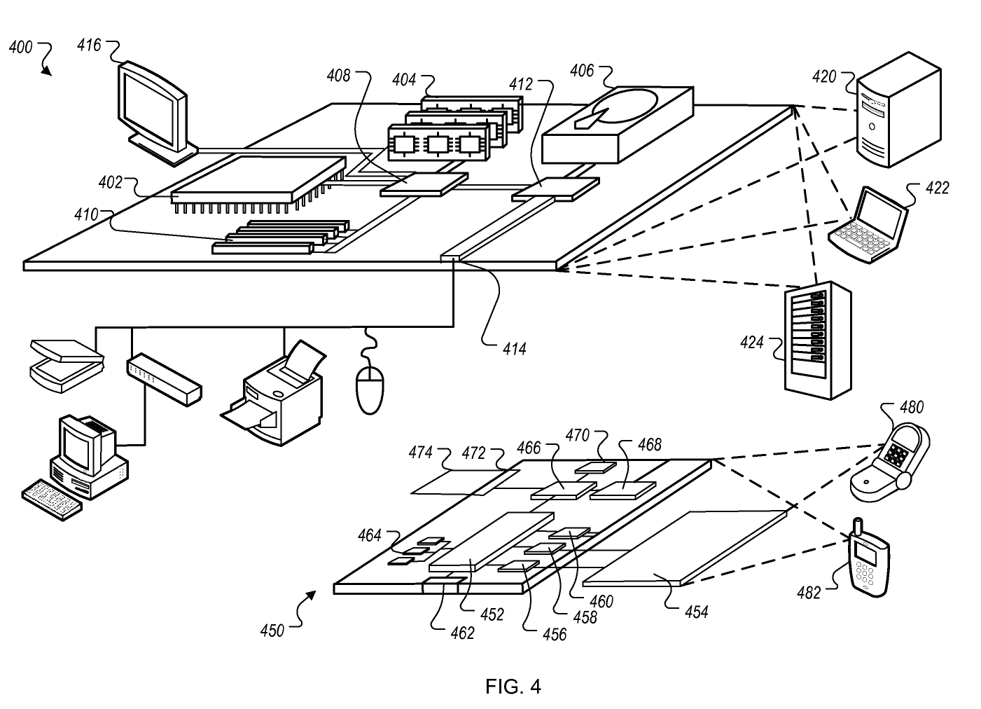

FIG. 4 is a block diagram of example computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 400 is further intended to represent any other typically non-mobile devices, such as televisions or other electronic devices with one or more processers embedded therein or attached thereto. Computing device 450 is intended to represent various forms of mobile devices, such as personal digital assistants, cellular telephones, smartphones, and other computing devices. The components shown here, their connections and relationships, and their functions, are meant to be examples only, and are not meant to limit implementations of the inventions described and/or claimed in this document.

Computing device 400 includes a processor 402, memory 404, a storage device 406, a high-speed controller 408 connecting to memory 404 and high-speed expansion ports 410, and a low-speed controller 412 connecting to low-speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high-speed controller 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high-speed controller 408 manages bandwidth-intensive operations for the computing device 400, while the low-speed controller 412 manages lower bandwidth-intensive operations. Such allocation of duties is an example only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed bus 414. The low-speed bus 414 (e.g., a low-speed expansion port), which may include various communication ports (e.g., USB, Bluetooth®, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as computing device 450. Each of such devices may contain one or more of computing devices 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The computing device 450 may also be provided with a storage device, such as a micro-drive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the computing device 450, such as control of user interfaces, applications run by computing device 450, and wireless communication by computing device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of computing device 450 with other devices. External interface 462 may provide, for example, for wired communication (e.g., via a docking procedure) or for wireless communication (e.g., via Bluetooth® or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to computing device 450 through expansion interface 472, which may include, for example, a subscriber identification module (SIM) card interface. Such expansion memory 474 may provide extra storage space for computing device 450, or may also store applications or other information for computing device 450. Specifically, expansion memory 474 may include instructions to carry out or supplement the processes described above, and may include secure information also. Thus, for example, expansion memory 474 may be provide as a security module for computing device 450, and may be programmed with instructions that permit secure use of computing device 450. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Computing device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through transceiver 468 (e.g., a radio-frequency transceiver). In addition, short-range communication may occur, such as using a Bluetooth®, WiFi, or other such transceiver (not shown). In addition, GPS receiver module 470 may provide additional wireless data to computing device 450, which may be used as appropriate by applications running on computing device 450.

Computing device 450 may also communicate audibly using audio codec 460, which may receive spoken information from a user and convert it to usable digital information. Audio codec 460 may likewise generate audible sound for a user, such as through a speaker, e.g., in a handset of computing device 450. Such sound may include sound from voice telephone calls, may include recorded sound (e.g., voice messages, music files, etc.) and may also include sound generated by applications operating on computing device 450.

The computing device 450 may be implemented in a number of different forms, as shown in the figure. For example, it may be implemented as a cellular telephone 480. It may also be implemented as part of a smartphone 482, personal digital assistant, or other mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. Other programming paradigms can be used, e.g., functional programming, logical programming, or other programming. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
adding a proxy server in between user devices and a server that hosts a resource on the web;
receiving, at the proxy server and from a user device, a page request addressed to the resource;
forwarding the received request to the server;
receiving, responsive to the forwarding and from the server, a page associated with the resource; and
processing, by the proxy server, the page including:
parsing the received page and locating content blocks in the page;
extracting slot information for each content block;
forwarding content requests for each content block to respective third-party content serving systems;
receiving responses to the content requests and merging the responses into the page at respective content blocks;
removing tags from one or more items in the responses and including a single tag in the processed page that is associated with the proxy server; and
storing a linking between the removed tags and the single tag associated with the proxy server; and
providing the processed page responsive to the received page request.

2. The method of claim 1 wherein adding the proxy server includes assigning the proxy server a domain name service name and associated internet protocol address associated with the resource.

3. The method of claim 1 further comprising dropping a cookie associated with the proxy server on the user device responsive to the received page request.

4. The method of claim 1 further comprising receiving an indication that the single tag associated with proxy server has fired, identifying the removed tags using the linking, and providing a response to one or more sponsors of the removed tags responsive to the received indication.

5. The method of claim 4 wherein the tags are tracking pixels or cookies.

6. The method of claim 1 further comprising linking cookies deposited directly by a content sponsor with cookies of the proxy server generated when content of the content sponsor is served in response to forwarded requests, wherein linking the cookies includes linking a cookie dropped on the user device by a content sponsor with the cookie associated with the proxy server based on the stored linking.

7. The method of claim 5 further comprising including, in a cookie dropped by a third-party content provider on the user device, a code that pings the proxy server to identify information associated with the third-party content sponsor known by the proxy server as a result of processing the page.

8. The method of claim 1 wherein the storing a linking includes storing an association between the proxy server tag and one or more of an identifier associated with content provided for a given response, an impression identifier, a page identifier for the page, a current time of impression or a uniform resource locator for a sponsor of the tag.

9. The method of claim 1 wherein the received page request includes a cookie associated with the publisher of the resource, the forwarded request includes the cookie associated with the publisher resource, and wherein processing the page includes inserting a cookie matching pixel in the processed page that fires a cookie matching event with a third-party content provider's server associated with a respective response.

10. The method of claim 1 wherein providing the processed page further includes initially providing a redirect request to redirect a requesting user device's browser associated with the received page request to a third-party content provider server associated with a respective response so as to enable the third-party content provider to drop a cookie directly on the user device's browser as a first-party cookie, and the method further comprising thereafter redirecting the user's browser back to the proxy server to enable processing of the page.

11. The method of claim 1 wherein the tags include script to pass request-specific, user-specific or publisher specific parameters to an associated tag sponsor when content associated with a respective response is rendered on a requesting device.

12. A computer program product embodied in a non-transitive computer-readable medium including instructions, that when executed, cause one or more processors to:
add a proxy server in between user devices and a server that hosts a resource on the web;
receive, at the proxy server and from a user device, a page request addressed to the resource;
forward the received request to the server;
receive, responsive to the forwarding and from the server, a page associated with the resource; and
process, by the proxy server, the page including:
parsing the received page and locating content blocks in the page;
extracting slot information for each content block;
forwarding content requests for each content block to respective third-party content serving systems;
receiving responses to the content requests and merging the responses into the page at respective content blocks;
removing tags from one or more items in the responses and including a single tag in the processed page that is associated with the proxy server; and
storing a linking between the removed tags and the single tag associated with the proxy server; and
provide the processed page responsive to the received page request.

13. The computer program product of claim 12 wherein adding the proxy server includes assigning the proxy server a domain name service name and associated internet protocol address associated with the resource.

14. The computer program product of claim 12 further comprising instructions to drop a cookie associated with the proxy server on the user device responsive to the received page request.

15. The computer program product of claim 12 further comprising instructions to receive an indication that the single tag associated with proxy server has fired, identify the removed tags using the linking, and provide a response to one or more sponsors of the removed tags responsive to the received indication.

16. The computer program product of claim 15 wherein the tags are tracking pixels or cookies.

17. A system comprising:
one or more processors; and
one or more memory elements including instructions that, when executed, cause the one or more processors to:
add a proxy server in between user devices and a server that hosts a resource on the web;
receive, at the proxy server and from a user device, a page request addressed to the resource;
forward the received request to the server;
receive, responsive to the forwarding and from the server, a page associated with the resource; and
process, by the proxy server, the page including:
parsing the received page and locating content blocks in the page;
extracting slot information for each content block;
forwarding content requests for each content block to respective third-party content serving systems;
receiving responses to the content requests and merging the responses into the page at respective content blocks;
removing tags from one or more items in the responses and including a single tag in the processed page that is associated with the proxy server; and
storing a linking between the removed tags and the single tag associated with the proxy server; and
provide the processed page responsive to the received page request.

18. The system of claim 17 wherein adding the proxy server includes assigning the proxy server a domain name service name and associated internet protocol address associated with the resource.

19. The system of claim 17 further comprising instructions to drop a cookie associated with the proxy server on the user device responsive to the received page request.

20. The system of claim 17 further comprising instructions to receive an indication that the single tag associated with proxy server has fired, identify the removed tags using the linking, and provide a response to one or more sponsors of the removed tags responsive to the received indication.
